(19) United States
(12) Patent Application Publication
(10) Pub. No.: US 2020/0110272 A1
(43) Pub. Date: Apr. 9, 2020

(54) EMERGENCY VISION SYSTEM WITH HAND-HELD ENCLOSURE

(71) Applicant: Christian Werjefelt, Kaneohe, HI (US)

(72) Inventor: Christian Werjefelt, Kaneohe, HI (US)

(21) Appl. No.: 16/559,028

(22) Filed: Sep. 3, 2019

Related U.S. Application Data
(60) Provisional application No. 62/733,348, filed on Sep. 19, 2018.

(51) Int. Cl. G02B 27/02; B64D 25/00; B64D 43/00; B64C 1/14; G02B 23/20; G02B 27/04; G02B 27/00

(52) U.S. Cl. CPC G02B 27/022; B64D 25/00; B64D 43/00; G02B 27/0006; G02B 23/20; G02B 27/04; B64C 1/1476

(57) ABSTRACT

A hand-held emergency vision device includes a hand-held emergency vision device having an enclosed tubular housing with a first end and a second end. The enclosed tubular housing has an expanded shape memory form. First and second clear members are provided at the first and second ends, respectively; and the tubular housing is compressible to an unexpanded compact form. The housing is releasably held in its compact form, and is self-expandable to its expanded shape memory form when released from its compact form.

### FIELD OF THE INVENTION

The present invention is generally directed to a system to enable an operator to maintain visual contact with instruments or other visual sources of data after smoke and/or particulate from a fire or other sources has invaded the operator's environment. In particular, the present invention relates to a system with a hand-held enclosure that provides a clear view of the instrument panel, relevant checklist, approach plate, keyboard, circuit breakers, fuses, control panel, etc., thereby providing a pilot with vital information for guiding the aircraft to a safe landing after smoke and/or particulate matter invades the cockpit area.

### BACKGROUND OF THE INVENTION

When cockpits are invaded by continuous, dense, blinding smoke that turn airplanes into unguided missiles, the results are well known to be catastrophic and fatal for passengers and crew. None creates an unsafe condition faster than a pilot blinded by continuous, opaque smoke. And none occurs as frequently as smoke in the cockpit. According to the Air Line Pilots Association, airliners make an unscheduled or emergency landing due to smoke in the cockpit on an average of once per day.

What is true for a cockpit is equally true for any operator station where the operator's ability to see the instrument panel when smoke invades the operator's station depends on the safe operation or orderly shutdown of critical processes, such as occur in a nuclear power station, submarine and similar operator stations.

Emergency vision devices for aiding pilots to see through vision-impairing smoke to maintain their visual access to critical information, such as that provided by an instrument panel and visual information available outside the cockpit to help pilots safely guide their aircrafts are disclosed in U.S. Pat. Nos. 4,832,287; 5,318,250; 5,202,798; and 5,947,415, all issued to Bertil Werjefelt.

The devices disclosed in the above-cited patents provide the primary means for providing an operator clear visibility to the instruments or sources of data during emergency smoke conditions. Generally, these devices require a pump or source of pressurized gas to inflate and deploy the devices. Some of the devices are generally designed for specific cockpit configurations so that once they are deployed, they are not typically movable around the cockpit. Consequently, the operator may not be able to view other sources of data which the operator may need to see but is not in the line of sight provided by the devices.

### SUMMARY OF THE INVENTION

The present invention provides a hand-held emergency vision device, including an enclosed tubular housing having a first end and a second end; the enclosed tubular housing having an expanded shape memory form; first and second clear members are disposed at the first and second ends, respectively; and the tubular housing being compressible to an unexpanded compact form, the housing being releasably held in its compact form, and being self-expandable to its expanded shape memory form when released from its compact form.

### BRIEF DESCRIPTION OF THE DRAWINGS

FIG. 1 is a schematic side elevational view of a cockpit showing a pilot using a hand-held emergency vision device embodying the present invention in an expanded form.

FIG. 2 is rear perspective view of the hand-held emergency vision device shown in FIG. 1 in an expanded form.

FIG. 3 is a front perspective view of the hand-held emergency vision device shown in FIG. 1 in an expanded form.

FIG. 4 is a cross-sectional view of the hand-held emergency vision device taken along line 4-4 in FIG. 2 in an expanded form.

FIG. 5 is a top perspective view of the hand-held emergency vision device shown in FIG. 1 in a compact form.

### DETAILED DESCRIPTION OF THE INVENTION

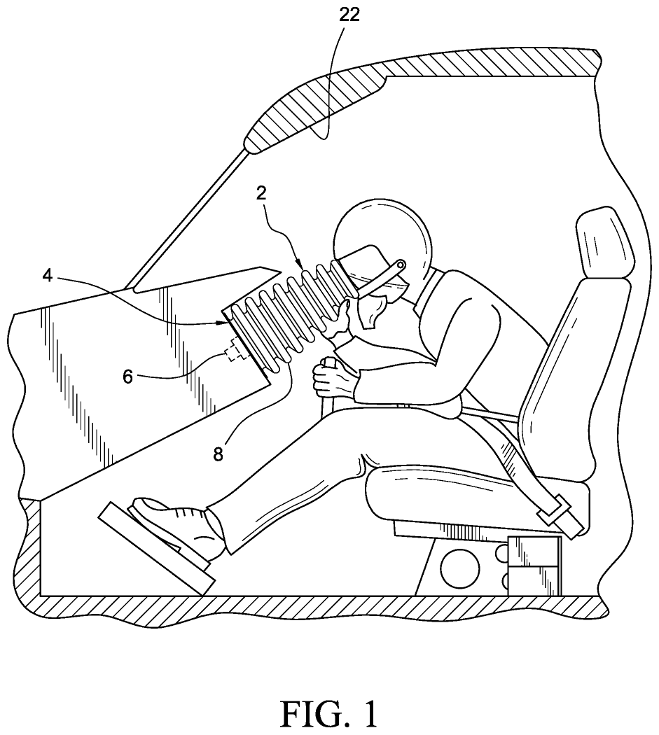

Referring to FIG. 1, a hand-held emergency vision device 2 is shown being used by a pilot during a smoke emergency to allow the pilot to see an instrument panel 4. Instrument panel 4 typically includes multiple gauges 6, and one of which is shown in broken line for clarity. Device 2 bridges the gap between the pilot and the instrument panel 4 with a clear viewing path to the instrument panel while the cockpit is filled with vision degrading smoke, thereby providing pilot with vital information for guiding the aircraft to a safe landing after smoke and/or particulate matter invades the cockpit area. Emergency vision device 2 is movable to other areas of the instrument panel or cockpit to direct the device 2 to wherever the pilot needs to view, such as switches, gauges, and the like, which might be above the pilot in some aircraft cockpits.

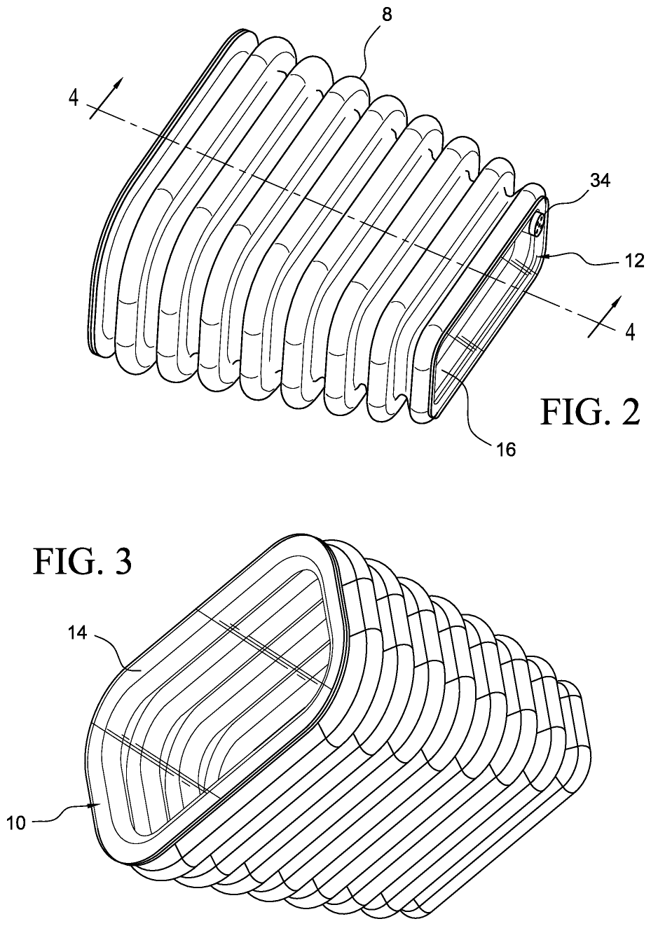

Referring to FIGS. 2 and 3, the device 2 comprises an enclosed tubular housing 8, in short enclosure 8, with a first end and a second end, which may be a front end 10 and a rear end 12 provided with first and second clear members 14 and 16, respectively. The device 2 is completely enclosed to contain clear air inside the housing 8 to allow the user to see through the distance between the clear members 14 and 16.

Housing 8 may be tapered, as shown.

First and second clear members 14 and 16 may be rigid.

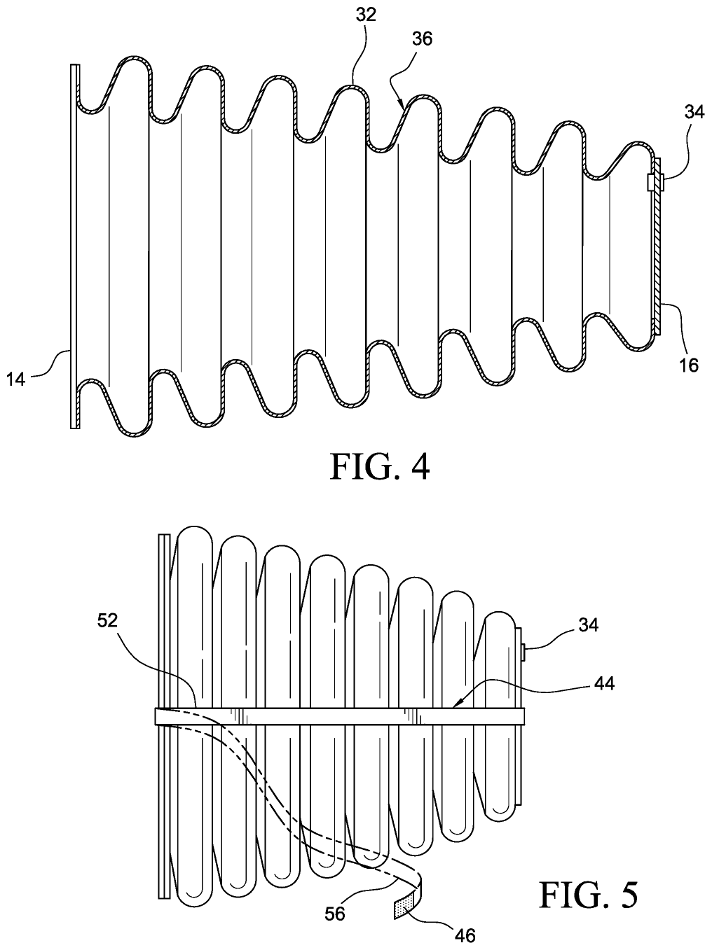

The device 2 has an expanded form, as shown in FIGS. 1-4, and may be compressed under a compressive force into an unexpanded compact form as shown in FIG. 5.

In order to see other areas in the cockpit not encompassed by the enclosure 8, the hand-held enclosure 8 may be moved, in use, allowing the user to view other areas of the cockpit, such as an overhead panel 22. As the hand-held enclosure 8 is movable, it can be readily repositioned to view any other area within the cockpit within reach. For example, a pilot may view a portion of overhead panel 22 by manually moving emergency vision device 2 from the position shown in FIG. 1, in which hand-held enclosure 8 is being used to view instrument panel 4, to a position in which device 2 is held against overhead panel 22 by the user.

Referring to FIGS. 2-4, enclosure 8 includes clear members 14 and 16 that allow the user to see through the enclosure. Enclosure 8 is tubular, preferably cylindrical, conical, or a rectangular (i.e., four-sided) enclosure, self-expandable by a shape memory of a pleated wall 32 of enclosure 8 that expands axially to draw ambient air through a filter 34, that is, axially outwardly so that front end 10 and rear end 12 move away from each other. Filter 34 may be located in and extend through front clear member 16, as shown. In that manner filter 34 is operably associated with the housing to filter the ambient atmosphere and fill the interior of the housing with filtered ambient air when the housing is expanded to the expanded form.

Pleated wall 32 has a plurality of accordion pleats 36 joined end-to-end, which assists in expanding enclosure 8 axially into its expanded use position. The shape memory of the pleated wall 32 provides the self-expansion of the enclosure 2 from its unexpanded compact form shown in FIG. 5 to its expanded form. The pleated wall 32 may be made of spring-like material, such as rubber or other materials with similar characteristics.

Referring to FIG. 5, a strap 44 is shown with a detachable fastener 46. The strap 44 is attached to a surface of the device 2 with a fixed fastener, such as at front end 10, or a detachable fastener, such as a hoop-and-loop fastener (e.g., a VELCRO™ hoop-and-loop fasteners).

Detachable fastener 46 may be provided at an end of strap 44, as shown in FIG. 5. Detachable fastener 46 may likewise be a hoop-and-loop fastener.

Strap 44 has a storing position 52 in which enclosure 8 is releasably held in its unexpanded compact form; and strap 44 has a loose, non-use position 56 when fastener 46 is detached.

The device 2 in the compact state may be stored in an area of the cockpit readily available to the user, for example.

Hand-held expandable device 2 gets its inflation air from device 2 expanding during use owing to its pleated wall 32 which are normally in an expanded shape. When compressed, wall 32 is held in its compact form by strap 44 in its storing configuration 52. When the strap 44 is released, the enclosure 2 automatically self-expands to its normal permanent shape, as shown in FIG. 4, due to the shape memory of the pleated wall 32.

It can be seen from the foregoing description that device 2 enables an operator to maintain visual contact with instruments or other visual sources of data after vision-obscuring matter, such as smoke and/or particulate matter from a fire, has invaded the operator's environment. In particular, the device 2 provides a clear view of instrument panel 4 in an aircraft cockpit, thereby providing the pilot with vital information for guiding the aircraft to a safe landing after such as smoke or other vision-obscuring matter, invades the cockpit area.

Although device 2 is shown in the context of an aircraft cockpit, the invention can be used in other similar environments where an operator in a station requires access to information from a source, such as an instrument panel, during a vision-obscuring emergency, such as a smoke generating event. Examples of operator stations are a submarine control station, a nuclear power plant control room, an oil rig or any other critical or military environments where the need exists for an operator to continue to operate in case of a vision-obscuring emergency, such as when smoke or other particulate matter invades the operator station and obliterates the visibility between the operator and the control panel. Accordingly, where the instruments, control panel or critical sources of information are disposed in an operator station, the operator must have visual access to the information in case a vision-obscuring event occurs in the operator station.

For example, in FIG. 1, the instrument or control panel 4 may be disposed in an operator station within a control room in those or other critical areas listed above.

While this invention has been described as having preferred design, it is understood that it is capable of further modifications, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

I claim:

1. A hand-held emergency vision device, comprising:
a) an enclosed tubular housing having a first end and a second end;
b) the enclosed tubular housing having an expanded shape memory form;
c) first and second clear members disposed at the first and second ends, respectively; and
d) the tubular housing being compressible to an unexpanded compact form, the housing being releasably held in its compact form, and being self-expandable to its expanded shape memory form when released from its compact form.

2. The hand-held emergency vision device as in claim 1, wherein:
a) a filter operably associated with the housing to filter the ambient atmosphere and fill the interior of the housing with filtered ambient air when the housing is expanded to its expanded shape memory form.

3. The hand-held emergency vision device as in claim 1, wherein:
a) a strap is provided for holding the housing in its releasably held compact form.

4. The hand-held emergency vision device as in claim 1, wherein:
a) the housing is tapered.

5. The hand-held emergency vision device as in claim 1, wherein:
a) the housing is four-sided.

6. The hand-held emergency vision device as in claim 1, wherein:
a) the first and second clear members are rigid.

7. The hand-held emergency vision device as in claim 1, wherein:
a) the housing including a pleated wall having a plurality of accordion pleats joined end-to-end; and
b) the plurality of accordion pleats is compressible to the compact form.

8. The hand-held emergency vision device as in claim 2, wherein:
a) the filter is provided adjacent one of the first and second clear members.

9. The hand-held emergency vision device as in claim 2, wherein:
a) the filter is provided in the second clear member.
